(19) United States
(12) Patent Application Publication
(10) Pub. No.: US 2002/0075370 A1
(43) Pub. Date: Jun. 20, 2002

(54) Ink jet printer having an image protective layer applying apparatus

(75) Inventor: Thomas F. Szlucha, Fairport, NY (US)

Correspondence Address: John E. Beck, Xerox Corporation, Xerox Square 20A, Rochester, NY, 14644, US

(73) Assignee: Xerox Corporation

(21) Appl. No.: 09/737,391

(22) Filed: Dec. 18, 2000

(51) Int. Cl. B05C 11/00

(52) U.S. Cl. 347/101; 101/416.1

(57) ABSTRACT

An ink jet printer is provided for producing high quality permanent ink images. The ink jet printer includes a frame in part defining a sheet travel path, a sheet supply and handling assembly mounted to the frame for supplying and moving a sheet through the sheet travel path, at least one printhead connected to an ink supply and located along the sheet travel path for printing ink images on the sheet moving through the sheet travel path; and an image protective layer applying apparatus for supplying and applying a moisture repelling protective layer on ink images printed on the sheet moving through the sheet travel path. The image protective layer applying apparatus includes a moisture repelling material, a holder for holding the moisture repelling material, and an applying member for applying a layer of the moisture repelling material on ink images printed on the sheet moving through the sheet travel path; thereby enabling production of high quality permanent ink images.

### BACKGROUND OF THE INVENTION

The present invention relates generally to printers such as ink jet printers, and more particularly to such a printer having an image protective layer applying apparatus for enabling production of high quality permanent images.

An ink jet printer of the type frequently referred to as drop-on-demand, has at least one printhead from which droplets of ink are directed towards a recording medium. Within the printhead, the ink is contained in a plurality of channels. Piezoelectric devices or power pulses cause the droplets of ink to be expelled as required, from orifices or nozzles located at the end of the channels. In thermal ink jet printing, the power pulses are usually produced by resistors also known as heaters, each located in a respective one of the channels. The heaters are individually addressable to heat and vaporize the ink in the channels. As a voltage is applied across a selected heater, a vapor bubble grows in that particular channel and ink bulges from the channel nozzle. At that stage, the bubble begins to collapse. The ink within the channel retracts and then separates from the bulging ink thereby forming a droplet moving in a direction away from the channel nozzle and towards the recording medium whereupon hitting the recording medium a spot is formed. The channel is then refilled by capillary action which, in turn, draws ink from a supply container of liquid ink.

The ink jet printhead may be incorporated into either a carriage type printer or a page width type printer. The carriage type printer typically has a relatively small printhead containing the ink channels and nozzles. The printhead is usually sealingly attached to a disposable ink supply cartridge and the combined printhead and cartridge assembly is attached to a carriage which is reciprocated to print one swath of information (equal to the length of a column of nozzles) at a time on a stationary recording medium, such as a sheet of paper or a transparency.

After each such swath is printed, the sheet of paper is transported or advanced forwardly (usually the movement involves stepping or indexing) a distance that is equal to the height of the printed swath or of a portion thereof so that the next printed swath is properly registered in an overlapping or contiguous manner therewith.

Current ink jet products produce images that have a significant shortfall in permanence. While various ink formulations address some of the attributes of image permanence, a total solution is not available within the spectrum of ink properties that are needed for adequate jetting and maintenance of the cartridge. Permanence attributes include waterfastness, resistance to “highlighter smear”, lightfastness, and the ability to resist handling damage. It is believed that in order for ink jet technology to compete with fused toner image technology, ink jet image permanence, approaching that of fused toner images, must be demonstrated.

Therefore is a need for ink jet printers including an economical image protective layer applying apparatus for enabling production of high quality permanent images.

### SUMMARY OF THE INVENTION

In accordance with the present invention, there has been provided an ink jet printer for producing high quality permanent ink images. The ink jet printer includes a frame, in part defining a sheet travel path; a sheet supply and handling assembly mounted to the frame for supplying and moving a sheet through the sheet travel path; at least one printhead connected to an ink supply and located along the sheet travel path for printing ink images on the sheet moving through the sheet travel path; and an image protective layer applying apparatus for supplying and applying a moisture repelling protective layer on ink images printed on the sheet moving through the sheet travel path. The image protective layer applying apparatus includes a moisture repelling material, a holder for holding the moisture repelling material, and an applying member for applying a layer of the moisture repelling material on ink images printed on the sheet moving through the sheet travel path, thereby enabling production of high quality permanent ink images.

### BRIEF DESCRIPTION OF THE DRAWINGS

In the detailed description of the invention presented below, reference is made to the drawings, in which:

FIG. 1 is a schematic illustration of a liquid ink printer including the image protective layer applying apparatus in accordance with the present invention; and

FIG. 2 is an enlarged illustration of the image protective layer applying apparatus of the present invention.

### DETAILED DESCRIPTION OF THE INVENTION

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

Although the present invention discussed herein may be used for drying any image which is created by a liquid ink printer, the description of the present invention will be described in the environment of an ink jet printer such as that shown in the drawings.

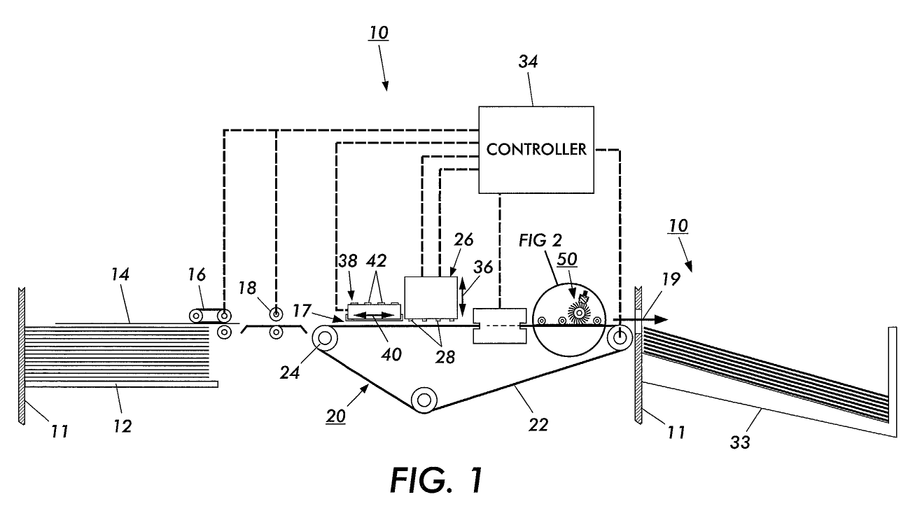

FIG. 1 illustrates a schematic elevational view of a liquid ink printer 10, for instance, an ink jet printer, of the present invention. The liquid ink printer 10 includes a frame 11 and an input tray 12 containing sheets of a recording medium 14 to be printed upon by the printer 10. Single sheets of the recording medium 14 are removed from the input tray 12 by a pickup device 16 and fed by feed rollers 18 to a transport mechanism 20. The transport mechanism 20 moves the sheet by a feed belt or belts 22 driven by rollers 24 along a sheet travel path 17 beneath a liquid ink printhead assembly 26 including at least one printhead 28 for printing ink images on such sheet or recording medium 14.

Preferably, the printhead assembly 26 includes one or more pagewidth printheads 28 that are each supported in a printing position by a printhead support (not shown) in a confronting relation with the belt 22. During printing, the pagewidth printheads 28 deposit liquid ink on the recording medium 14 as it is carried by the belt 22 beneath and passed such printheads 28. Each of the pagewidth printheads 28 includes an array of print nozzles, for instance, staggered or linear arrays, having a length sufficient to deposit ink in a print zone across the width of the recording medium 14. The present invention is equally applicable, however, to printers having partial width array ink jet printheads. The printhead assembly 26 also includes an ink supply either attached to the printhead support or coupled to the pagewidth printheads through appropriate supply tubing. The recording medium 14 is then carried by the belt 22 through a dryer assembly 32, and passed the image protective layer applying apparatus 50 of the present invention (to be described more fully below). After that, the sheet 14 with a high quality and protected or permanent ink image thereon is unloaded into an output tray 33.

A controller 34 controls the operation of the transport mechanism 20, which includes the pickup device 16, the feed roller 18 and the drive roller 24. In addition, the controller 34 controls the movement of the printhead assembly 26, and particularly printing by the printheads 28. The controller 34 can also include a plurality of individual controllers, such as microprocessors or other known devices dedicated to perform a particular function.

At the completion of a printing operation or when otherwise necessary, such as during a power failure, the printhead assembly 26, which is movable in the directions of an arrow 36, is moved away from the belt 22 such that a capping assembly 38, movable in the directions of the arrow 40, is moved beneath the printhead assembly 26 for capping thereof. Once the cap assembly 38 is positioned directly beneath the printhead assembly 26, the printhead assembly 26 is moved towards the belt 22 and into contact with a plurality of capping gaskets 42 located on the cap assembly 38.

As illustrated, the cap assembly 38 includes one or more capping gaskets 42 which engage or contact the page width printheads on an area surrounding one or more of the printheads to thereby seal the printhead nozzles from exposure to air. Once a capping operation is complete, the printhead assembly 26 moves away from the belt 22 and the cap assembly 38 moves away from the printhead assembly 26 such that the printhead assembly 26 can be positioned appropriately with respect to the belt 22 for printing on the recording sheets 14.

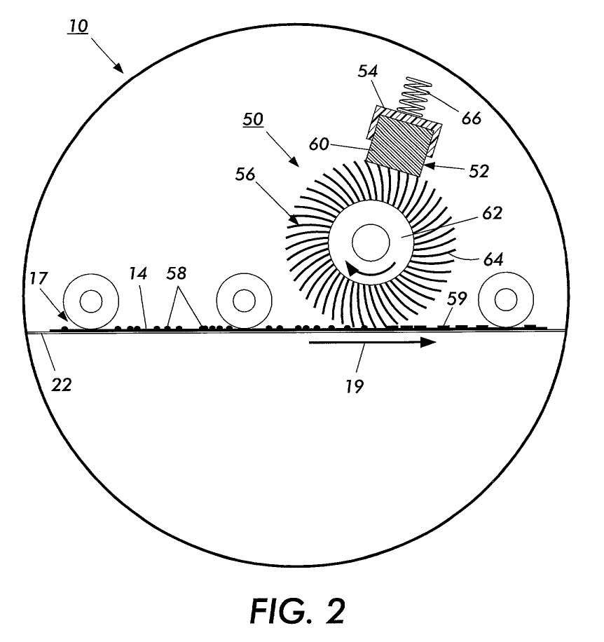

Referring now to FIGS. 1 and 2, the ink jet printer 10 in accordance with the present invention includes an image protective layer applying apparatus 50 for supplying and applying a moisture repelling protective layer on ink images printed on the sheet or recording medium 14 moving through the sheet travel path 17. As shown, the image protective layer applying apparatus 50 includes a moisture repelling material 52 or moisture and stain resistant material, a holder 54 for holding the moisture repelling material, and an applying member 56 for applying a layer of the moisture repelling material onto ink images 58 printed on the sheet 14 moving through the sheet travel path 17. The moisture and stain resistant or moisture repelling material 52 of the present invention is of course not limited to only to the suggested embodiments of paraffin and polyethylene. Other materials that possess similar properties are of course understood to be equally applicable.

Thus in accordance with the present invention, the moisture repelling material 52 is for example a polyethylene material, preferably a low molecular weight polyethylene or a paraffin or wax. Specifically, the moisture repelling material 52 for example is a soft wax material, in the form of a solid bar 60 of such wax. The applying member 56 for example is a rotating brush 62 that is mounted for rotatably contacting the moisture repelling material or solid bar 60 of wax material, as well as printed ink images 58 on the sheet 14 moving through the sheet travel path, and downstream of the dryer 32 (FIG. 1), as shown. The rotating brush 62 includes protruding fibers 64 for frictionally contacting the moisture repelling material or bar of wax 52 and wearing away at the bar of wax, before contacting the sheet 14. The holder 54 therefore includes means such as a spring 66 for gradually urging and moving the moisture repelling material or bar of wax towards the applying member or brush 62 as the bar of wax wears away through use.

In accordance with the present invention, use of a protective layer of a moisture and stain resistant material such as a soft wax material (paraffin) or a low molecular weight polyethylene, on the surface of an ink jet image was found to improve image permanence. Permanence attributes include waterfastness, resistance to “highlighter smear”, lightfastness, and the ability to resist handling damage.

The protective layer preferably is applied by buffing the surface of the media or sheet 14 with a rotating cloth or fibrous brush 62, while the sheet is held down for example by edge rollers 25. In operation, the brush 62 first comes into contact with the solid bar 60 of the wax material 52 before contacting ink images on the sheet 14. Friction generated during contact between the fibers 64 of the brush and the bar 60 of wax, causes a layer 59 of the wax to soften, be picked up by the brush fibers 64 which then deposit the picked up wax onto the printed media or sheet 14. The deposited wax creates a thin coating or layer, over the ink images on the sheet 14, that is invisible to the naked eye but achieves the desirable result of forming a protective layer 59 on, and improving the permanence and quality of the ink images.

Bench tests have been conducted with household paraffin wax, using a workshop buffing wheel with very promising results. More tests are planned with hardware that allow more control of the conditions. This concept is not limited to paraffin and polyethylene. There are other materials that possess similar properties that will also be investigated.

As can be seen, there has been provided an ink jet printer for producing high quality permanent ink images. The ink jet printer includes a frame in part defining a sheet travel path, a sheet supply and handling assembly mounted to the frame for supplying and moving a sheet through the sheet travel path, at least one printhead connected to an ink supply and located along the sheet travel path for printing ink images on the sheet moving through the sheet travel path; and an image protective layer applying apparatus for supplying and applying a moisture repelling protective layer on ink images printed on the sheet moving through the sheet travel path. The image protective layer applying apparatus includes a moisture repelling material, a holder for holding the moisture repelling material, and an applying member for applying a layer of the moisture repelling material on ink images printed on the sheet moving through the sheet travel path; thereby enabling production of high quality permanent ink images.

While the present invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

We claim:

1. An ink jet printer for producing high quality permanent images comprising:
(a) a frame in part defining a sheet travel path;
(b) a sheet supply and handling assembly mounted to said frame for supplying and moving a sheet through said sheet travel path;
(c) at least one printhead connected to an ink supply and located along said sheet travel path for printing ink images on the sheet moving through said sheet travel path; and
(d) an image protective layer applying apparatus for supplying and applying a moisture repelling protective layer on ink images printed on the sheet moving through said sheet travel path, said image protective layer applying apparatus including a moisture repelling material, a holder for holding said moisture repelling material, and an applying member for applying a layer of said moisture repelling material on the ink images printed on the sheet moving through said sheet travel path; thereby enabling production of high quality permanent ink images.

2. The ink jet printer of claim 1, wherein said moisture repelling material comprises polyethylene.

3. The ink jet printer of claim 1, wherein said applying member comprises a rotating brush mounted for rotatably contacting said moisture repelling material as well as the printed ink images on the sheet moving through said sheet travel path.

4. The ink jet printer of claim 1, wherein said holder includes means for gradually moving said moisture repelling material towards said applying member.

5. The ink jet printer of claim 2, wherein said polyethylene is a soft wax material.

6. The ink jet printer of claim 2, wherein said polyethylene comprise a low molecular weight polyethylene.

7. The ink jet printer of claim 2, wherein said polyethylene is a bar of soft wax material.

8. The ink jet printer of claim 3, wherein said rotating brush includes protruding fibers for frictionally contacting said moisture repelling material and the sheet moving through said sheet travel path.
